(19) United States
(12) Patent Application Publication
(10) Pub. No.: US 2026/0333482 A1
(43) Pub. Date: Oct. 22, 2026

(54) DEVICE PAIR CONNECTIONS

(71) Applicant: Hewlett-Packard Development Company, L.P., Spring, TX (US)

(72) Inventors: Yi-Jin Li, Taipei City (TW); Chung-Chun Chen, Taipei City (TW); Wei-Ming Lo, Taipei City (TW)

(73) Assignee: Hewlett-Packard Development Company, L.P., Spring, TX (US)

(21) Appl. No.: 19/122,860

(22) PCT Filed: Oct. 31, 2022
(86) PCT No.: PCT/US2022/048380

§ 371 Date: Apr. 21, 2025

(51) Int. Cl. H04W 76/15; H04L 69/18; H04W 88/06

(52) U.S. Cl. CPC H04W 76/15; H04L 69/18; H04W 88/06

(57) ABSTRACT

An example device may comprise a computing device comprising a processor resource and a memory resource storing instructions to cause the processor resource to receive an initialization signal from a peripheral device to pair with the peripheral device utilizing a first wireless connection, connect with the peripheral device utilizing the first wireless connection, in response to establishing the first wireless connection, utilize the first wireless connection to receive a signal from the peripheral device to connect with the peripheral device utilizing a second wireless connection, and connect with the peripheral device utilizing the second wireless connection, wherein the computing device is connected to the peripheral device via the first wireless connection and the second wireless connection.

### BACKGROUND

Users of computing devices may utilize their computing devices for various purposes. A computing device can allow a user to utilize computing device operations for work, education, gaming, multimedia, and/or other general use. Certain computing devices can be wirelessly connected to a peripheral device. In some examples, the peripheral device can include a speaker and can convert audio signals received from the computing device to sound.

### BRIEF DESCRIPTION OF THE DRAWINGS

FIG. 1 is a block diagram of an example of a computing device pairing to a peripheral device.

FIG. 2 is a block diagram of an example of a first wireless connection and a second wireless connection between a computing device and a peripheral device.

FIG. 3 is a block diagram of an example of a peripheral device pairing to a computing device.

FIG. 4 illustrates an example of a first wireless connection and a second wireless connection between a computing device and a peripheral device.

FIG. 5 is a block diagram of an example of a system for pairing a computing device and a peripheral device.

### DETAILED DESCRIPTION

A user may utilize a computing device for various purposes, such as for business and/or recreational use. As used herein, the term computing device refers to an electronic device having a processor and a memory resource. Examples of computing devices include, for instance, a laptop computer, a notebook computer, a desktop computer, and/or a mobile device (e.g., a smart phone, tablet, personal digital assistant, smart glasses, a wrist-worn device, etc.), among other types of computing devices.

In some examples, the computing device can pair with and connect wirelessly to a peripheral device utilizing a wireless protocol. As used herein, the term “peripheral device” refers to a device outside of a computing device's system unit. The peripheral device may be an electronic device having a processor and a memory resource. As used herein, the term “pair” refers to an establishment of a connection between a base unit (e.g., a computing device) and a wireless device (e.g., a peripheral device). As used herein, the term “protocol” refers to a set of rules governing an exchange or transmission of data between devices.

In some examples, the peripheral device may receive audio signals from the computing device connected to the peripheral device. As used herein, the term “signal” refers to a detectable electrical impulse in which information can be transmitted. The peripheral device may convert the audio signals to sound that can be transmitted and heard through a speaker of the peripheral device. In some examples, the peripheral device may be a headset, earphones, and/or other devices that include a speaker. Although examples of audio devices for peripheral devices are given as examples, other types of peripheral devices can be utilized in a similar way.

In some examples, the computing device may be utilized to listen to music, a book, a video, and/or the like. The user may pair the computing device with the peripheral device to listen to the music, book, video, and/or the like through the peripheral device utilizing a wireless protocol. Pairing the computing device with the peripheral device may include interaction between the user and the computing device and between the user and the peripheral device. For example, the user may activate the protocol on the computing device (e.g., turn on the protocol), cause the peripheral device to be discoverable, and select the correct peripheral device in a menu displayed by the computing device, though examples of pairing processes are so limited. Execution of each action may vary depending on the computing device and the peripheral device and may include multiple user interactions. For example, causing the peripheral device to be discoverable may include turning on the peripheral device, toggling a switch, pressing a button, selecting a displayed course of action, etc. Activating the protocol on the computing device and selecting the correct peripheral device may include a series of windows and selectable navigational links, icons, and/or buttons, though examples are not so limited and may be dependent upon the computing device system.

In some examples, the computing device may be utilized as a gaming device. The user may utilize the peripheral device to receive sound from the game, interact with the game, communicate with another user of a different computing device playing the game, etc. A connection between the computing device and the peripheral device that may be sufficient when utilized in listening to music, a book, a video, etc., may not be sufficient in a gaming environment and may lag and/or otherwise under perform. As such, a second wireless protocol may be utilized that includes a faster response time. To connect the computing device with the peripheral device utilizing the second protocol, the user may have to execute the same lengthy and timely pairing process as when pairing with the first protocol.

The present disclosure relates to connecting a computing device to a peripheral device through both a first wireless connection utilizing a first protocol and a second wireless connection utilizing a second protocol by pairing one time utilizing the first wireless connection. Dual connecting the computing device to the peripheral device to utilize a first wireless protocol and a second wireless protocol by performing one pairing process reduces connectivity time and complexity, increases efficiency, and is less burdensome to the user.

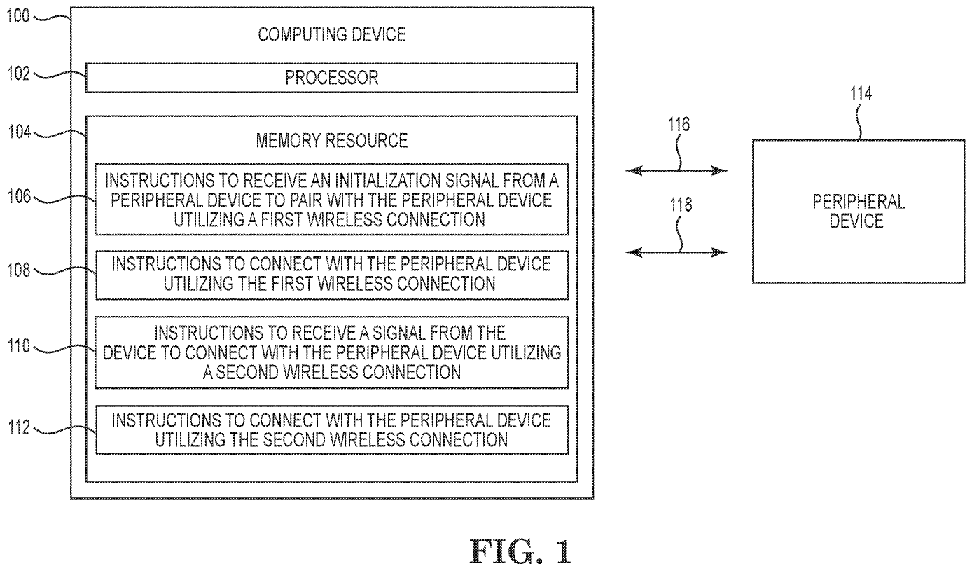

FIG. 1 is a block diagram of an example of a computing device 100 pairing to a peripheral device 114. In some examples, the computing device 100 includes a processor 102 communicatively coupled to a memory resource 104. As described further herein, the memory resource 104 includes instructions 106, 108, 110, 112 stored on the memory resource 104 and executed by the processor 102 to perform particular functions.

As used herein, the processor 102 includes, but is not limited to: a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions 106, 108, 110, 112. In other examples, the computing device 100 includes instructions 106, 108, 110, 112, stored on a machine-readable medium (e.g., memory resource 104, non-transitory computer-readable medium, etc.) and executable by the processor 102. In a specific example, the computing device 100 utilizes a non-transitory computer-readable medium storing instructions 106, 108, 110, 112, that, when executed, cause the processor 102 to perform corresponding functions.

The memory resource 104 may be electronic, magnetic, optical, or other physical storage device that stores executable instructions. Thus, a non-transitory machine-readable medium (MRM) (e.g., the memory resource 104) may be, for example, a non-transitory MRM comprising Random-Access Memory (RAM), read-only memory (ROM), an Electrically-Erasable Programmable ROM (EEPROM), a storage drive, an optical disc, and the like. The non-transitory machine-readable medium (e.g., the memory resource 104) may be disposed within a controller and/or computing device. In this example, the executable instructions 106, 108, 110, 112, can be “installed” on the device. Additionally, and/or alternatively, the non-transitory machine-readable medium (e.g., the memory resource 104) can be a portable, external or remote storage medium, for example, that allows a computing system to download the instructions 106, 108, 110, 112, from the portable/external/remote storage medium. In this situation, the executable instructions may be part of an “installation package.” As described herein, the non-transitory machine-readable medium (e.g., the memory resource 104) can be encoded with executable instructions for determining whether a fluid level of a fluid ejection device exceeds a threshold capacity.

In some examples, the computing device 100 may be paired with the peripheral device 114 to connect with the peripheral device 114 through a first wireless connection 116 utilizing a first wireless protocol and a second wireless connection 118 utilizing a second wireless protocol. As used herein, the term “wireless connection” refers to an establishment of a communication session through corresponding communication hardware. For example, the first wireless protocol may be activated on the computing device 100 (e.g., turning on the protocol). Activating the first wireless protocol may allow the computing device 100 to recognize peripheral devices available to pair with the computing device 100. The peripheral device 114 may be set to a wirelessly discoverable mode (e.g., turning on the device, toggling a switch, pressing a button, selecting a mode on the peripheral device 114, etc.). As such, the peripheral device 114 may send an initialization signal to pair with the computing device 100.

In some examples, the memory resource 104 includes instructions 106 that are executed by the processor 102 to receive the initialization signal from the peripheral device 114. The initialization signal may be a signal received from the peripheral device 114 to pair with the peripheral device 114 utilizing the first wireless connection 116.

In some examples, the memory resource 104 includes instructions 108 that are executed by the processor 102 to connect with the peripheral device 114. In some examples, the computing device 100 may present the peripheral device 114 as available for pairing on a display for a user to select and confirm connection. In some examples, the computing device 100 may connect with the peripheral device 114 without user interaction. The computing device 100 may wirelessly connect with the peripheral device 114 through the first wireless protocol utilizing the first wireless connection 116. The computing device 100 may establish the connection with the peripheral device 114 through a handshake protocol of the first wireless protocol. As used herein, the term “handshake protocol” refers to a public key infrastructure that established a shared symmetric key between devices to ensure confidentiality and integrity of communication of data between the devices. As such, the first wireless connection 116 may utilize the first wireless protocol for communication between the computing device 100 and the peripheral device 114.

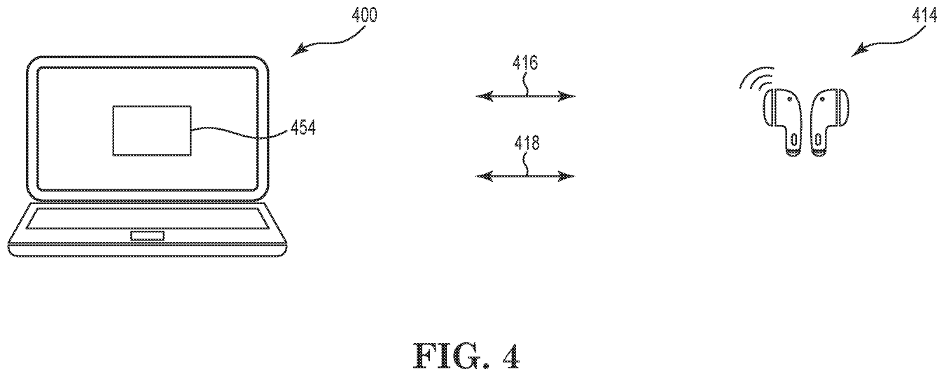

In some examples, the memory resource 104 includes instructions 110 that are executed by the processor 102 to receive a signal from the peripheral device 114 utilizing the previously established first wireless connection 116. The signal may be received in response to the computing device 100 establishing the first wireless connection 116 with the peripheral device 114. For example, the signal may be an unsolicited signal (e.g., made without user interaction with either device). The computing device 100 may receive the signal from the peripheral device 114 to connect with the peripheral device 114 utilizing the second wireless connection 118. The computing device 100 may receive the signal from the peripheral device 114 to connect with the peripheral device 114 utilizing the second wireless protocol. In some examples, prior to establishing the second wireless connection 118, the processor 102 may execute instructions to display a pop-up window to confirm connecting with the peripheral device 114 utilizing the second wireless connection 118, as is further illustrated in reference to FIG. 4.

In some examples, the memory resource 104 includes instructions 112 that are executed by the processor 102 to connect with the peripheral device 114 through the second wireless protocol utilizing the second wireless connection 118. As such, the second wireless connection 118 may utilize the second wireless protocol for communication between the computing device 100 and the peripheral device 114. The computing device 100 may establish the connection with the peripheral device 114 through a handshake protocol of the second wireless protocol. As such, the computing device 100 may be connected to the peripheral device 114 via the first wireless connection 116 and the second wireless connection 118.

In some examples, the computing device 100 may unassistedly (e.g., without user interaction) connect to the second wireless connection 118 of the peripheral device 114. As such, after the second wireless connection 118 is established between the computing device 100 and the peripheral device 114, the processor 102 may execute instructions to display a pop-up window including a connection completion notification, as is further illustrated in reference to FIG. 4.

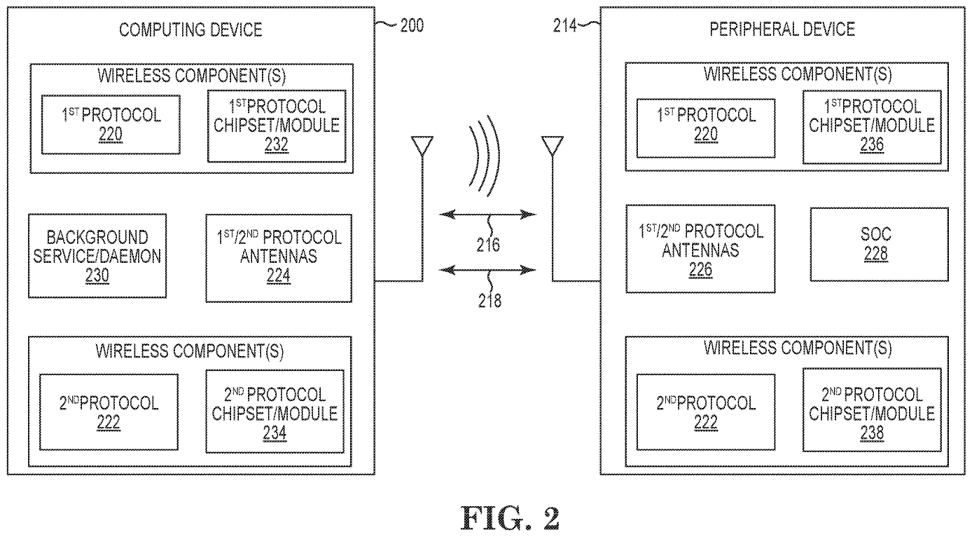

FIG. 2 is a block diagram of an example of a first wireless connection 216 and a second wireless connection 218 between a computing device 200 and a peripheral device 214. As described herein, in reference to FIG. 2, the computing device 200 may be connected to the peripheral device 214 utilizing a first wireless protocol 220 via the first wireless connection 216 and a second wireless protocol 222 via the second wireless connection 218.

In some examples, the computing device 200 may include a first chipset module 232 for the first wireless protocol 220 and a second chipset module 234 for a second wireless protocol 222. Correspondingly, the peripheral device 214 may include a third chipset module 236 for the first wireless protocol 220 and a fourth chipset module 238 for the second wireless protocol 222. As used herein, the term “chipset module” refers to a set of electronic components found on a circuit board of a device that through one or more integrated circuits manage data flow between the processor of the device, the memory the device, and an external device.

The first wireless protocol 220 may be a Bluetooth (BT) protocol. As such, the first wireless connection 216 may utilize the BT protocol. The computing device 200 and the peripheral device 214 may include firmware with instructions for utilization of the BT protocol. As used herein, the term “Bluetooth” refers to a short-range standardized protocol for sending and receiving data via a 2.4 GHz wireless link. As used herein, the term “firmware” refers to a permanent software programmed into a read-only memory that provides a low level control for a device's specific hardware. The second wireless protocol 222 may be an Ultra Low Latency (ULL) protocol. As such, the second wireless connection 218 may utilize the ULL protocol. The computing device 200 and the peripheral device 214 may include firmware with instructions for utilization of the ULL protocol. As used herein, the term “Ultra Low Latency” refers to a protocol for wirelessly sending and receiving data that has a transfer rate measured in nanoseconds. The ULL protocol may transfer rapidly changing data at a faster response time (e.g., real-time streaming) with fewer delays than the BT protocol while the BT protocol may utilize less power to operate than the ULL protocol. For example, the ULL protocol may be utilized for gaming purposes and the BT protocol may be utilized for listening to music, books, and/or videos, though examples are not so limited.

As previously described in connection with FIG. 1, the computing device 200 may be paired with and wirelessly connected with the peripheral device 214 via the first wireless connection 216 utilizing the first wireless protocol 220 (e.g., BT). The first wireless connection 216 may utilize the first wireless protocol 220 for communication between the computing device 200 and the peripheral device 214. The computing device 200 may utilize antenna 224 to transmit to and receive signals from the peripheral device 214. The peripheral device 214 may utilized antenna 226 to transmit to and receive signals from the computing device 200. As used herein, the term “antenna” refers to an apparatus used for sending and receiving electromagnetic waves.

The computing device 200 may include a daemon 230. As used herein, the term “daemon” refers to a program of a computing device that operates in the background but remains inactive until invoked. In some examples, after the first wireless connection 216 utilizing the BT protocol is established between the computing device 200 and the peripheral device 214, the daemon 230 of the computing device 200 may instruct the computing device 200 to enter a second pairing mode with the peripheral device 214.

The peripheral device 214 may include a System on Chip (SoC) 228. As used herein, the term “System on Chip” refers to a chip integrated circuit that may hold components of an electronic device (e.g., CPU, memory, input/output ports, secondary storage, etc.). In some examples, after the first wireless connection 216 utilizing the BT protocol is established between the peripheral device 214 and the computing device 200, the SoC 228 of the peripheral device 214 may instruct the peripheral device 214 to enter the second pairing mode with the computing device 200. The SoC 228 may send a Media Access Control (MAC) Address of the second wireless protocol 222 (e.g., ULL) to the computing device 200. As used herein, the term “Media Access Control Address” refers to a unique identifier assigned to a network interface controller for use as a network address in communications within a network segment. The MAC Address of the ULL protocol may be sent, via peripheral device antenna 226, to the computing device 200 utilizing the previously established first wireless connection 216.

As such, the computing device 200 may receive, via computing device antenna 224, from the peripheral device 214, the MAC Address associated with the second wireless connection 218 of the peripheral device 214 via the first wireless connection 216. The daemon 230 of the computing device 200 may receive the MAC Address and may instruct the computing device 200 to connect with the peripheral device 214 utilizing the ULL protocol via the second wireless connection 218. In some examples, after the second wireless connection 218 is established a pop-up window may be presented on the computing device 200 to display a connection completion notification, as is further illustrated in reference to FIG. 4.

In this way, a user may connect the computing device 200 and the peripheral device 214 to the BT protocol utilizing the first wireless connection 216 by pairing the computing device 200 with the peripheral device 214, as is further described in connection with FIG. 1. Additionally, the first connection may trigger the computing device 200 and the peripheral device 214 to connect to the ULL protocol utilizing the second wireless connection 218. The second wireless connection 218 process may be completed in the background (e.g., without user interaction) between the daemon 230 of the computing device 200 and the SoC 228 of the peripheral device 214 by transmitting and receiving signals between the computing device antenna 224 and the peripheral device antenna 226.

In this example, the first chipset module 232 of the computing device 200 and the third chipset module 236 of the peripheral device 214 may support the BT protocol. As such, the BT protocol between the computing device 200 and the peripheral device 214 may be governed by the first chipset module 232 and the third chipset module 236. Correspondingly, the second chipset module 234 of the computing device 200 and the fourth chipset module 238 of the peripheral device 214 may support the ULL protocol. As such, the ULL protocol may be governed by the second chipset module 234 and the fourth chipset module 238.

In some examples, the first wireless protocol 220 may be the ULL protocol. As such, the first wireless connection 216 may utilize the ULL protocol. The second wireless protocol 222 may be the BT protocol. As such, the second wireless connection 218 may utilize the BT protocol. As previously described in connection with FIG. 1, the computing device 200 may be paired with and wirelessly connected with the peripheral device 214 via the first wireless connection 216 utilizing the first wireless protocol 220 (e.g., ULL).

As previously described, the computing device 200 may utilize antenna 224 and the peripheral device 214 may utilize antenna 226 to transmit and receive signals between the computing device 200 and the peripheral device 214. As such, wireless connections between the computing device 200 and the peripheral device 214 may be established utilizing the computing device antenna 224 and the peripheral device antenna 226.

The computing device 200 and the peripheral device 214 may connect through the first wireless protocol 220 being the ULL protocol and the second wireless protocol 222 being the BT protocol utilizing a first process. In some examples, after the first wireless connection 216 utilizing the ULL protocol is established between the computing device 200 and the peripheral device 214, the daemon 230 of the computing device 200 may instruct the computing device 200 to enter the second pairing mode with the peripheral device 214. In some examples, after the first wireless connection 216 utilizing the ULL protocol is established between the peripheral device 214 and the computing device 200, the SoC 228 of the peripheral device 214 may instruct the peripheral device 214 to enter the second pairing mode with the computing device 200.

The SoC 228 of the peripheral device 214 may send a Media Access Control (MAC) Address of the second wireless protocol 222 (e.g., BT) to the computing device 200. The MAC Address of the BT protocol may be sent to the computing device 200 utilizing the previously established first wireless connection 216. The daemon 230 of the computing device 200 may receive the MAC Address and may instruct the computing device 200 to connect with the peripheral device 214 utilizing the BT protocol via the second wireless connection 218. In some examples, prior to establishing the second wireless connection 218, a pop-up window may be displayed on the computing device 200 to confirm connection with the peripheral device 214 via the BT protocol, as is further illustrated in reference to FIG. 4. As such, the user may confirm the second wireless connection 218 prior to establishing the second wireless connection 218.

In this way, a user may connect the computing device 200 and the peripheral device 214 to the ULL protocol utilizing the first wireless connection 216 by pairing the computing device 200 with the peripheral device 214, as further describe in connection with FIG. 1. Additionally, the first connection may trigger the computing device 200 and the peripheral device 214 to connect to the BT protocol utilizing the second wireless connection 218. The second wireless connection 218 process may be completed in the background (e.g., without user interaction) between the daemon 230 of the computing device 200 and the SoC 228 of the peripheral device 214 by transmitting and receiving signals between the computing device antenna 224 and the peripheral device antenna 226. The user may confirm the second wireless connection 218.

In this example, the first chipset module 232 of the computing device 200 and the third chipset module 236 of the peripheral device 214 may support the ULL protocol. As such, the ULL protocol between the computing device 200 and the peripheral device 214 may be governed by the first chipset module 232 and the third chipset module 236. Correspondingly, the second chipset module 234 of the computing device 200 and the fourth chipset module 238 of the peripheral device 214 may support the BT protocol. As such, the BT protocol may be governed by the second chipset module 234 and the fourth chipset module 238.

The computing device 200 and the peripheral device 214 may connect through the first wireless protocol 220 being the ULL protocol and the second wireless protocol 222 being the BT protocol utilizing a second process. In some examples, the computing device 200 may be paired with and wirelessly connected with the peripheral device 214 via the first wireless connection 216 utilizing the first wireless protocol 220 (e.g., ULL), as is previously described in connection with FIG. 1. In some examples, the second wireless connection 218 may utilize the BT protocol as described herein.

In some examples, in response to pairing with the computing device 200 via the ULL protocol, the SoC 228 of the peripheral device 214 may send a swift pairing package to the computing device 200 via the first wireless connection 216 utilizing the peripheral device antenna 226. The computing device 200 may receive the swift pairing package from the peripheral device 214 via the computing device antenna 224. As used herein, the term “swift pairing” refers to a notification to pair received while a peripheral device is nearby another device and is ready to pair. The swift pairing package may include a definition of the class of the peripheral device or a name of the peripheral device.

A pop-up window may be displayed on the computing device 200 to confirm connection with the peripheral device 214 via the swift pairing, as is further illustrated in reference to FIG. 4. Connecting the computing device 200 to the peripheral device 214 via the swift pairing may include connecting to the BT protocol utilizing the second wireless connection 218.

In this way, a user may connect the computing device 200 and the peripheral device 214 to the ULL protocol utilizing the first wireless connection 216 by pairing the computing device 200 with the peripheral device 214, as is further describe in connection with FIG. 1. Additionally, the first connection may trigger the peripheral device 214 to send a swift pairing package via the first wireless connection 216 to connect to the computing device 200 via the BT protocol utilizing the second wireless connection 218. The second wireless connection 218 setup may be completed in the background (e.g., without user interaction) between the daemon 230 of the computing device 200 and the SoC 228 of the peripheral device 214 by transmitting and receiving signals between the computing device antenna 224 and the peripheral device antenna 226. The user may confirm connecting the computing device 200 with the peripheral device 214 via the swift pairing notification pop-up displayed on the computing device 200.

In this example, the ULL protocol between the computing device 200 and the peripheral device 214 may be governed by the first chipset module 232 and the third chipset module 236. Correspondingly, the BT protocol may be governed by the second chipset module 234 and the fourth chipset module 238.

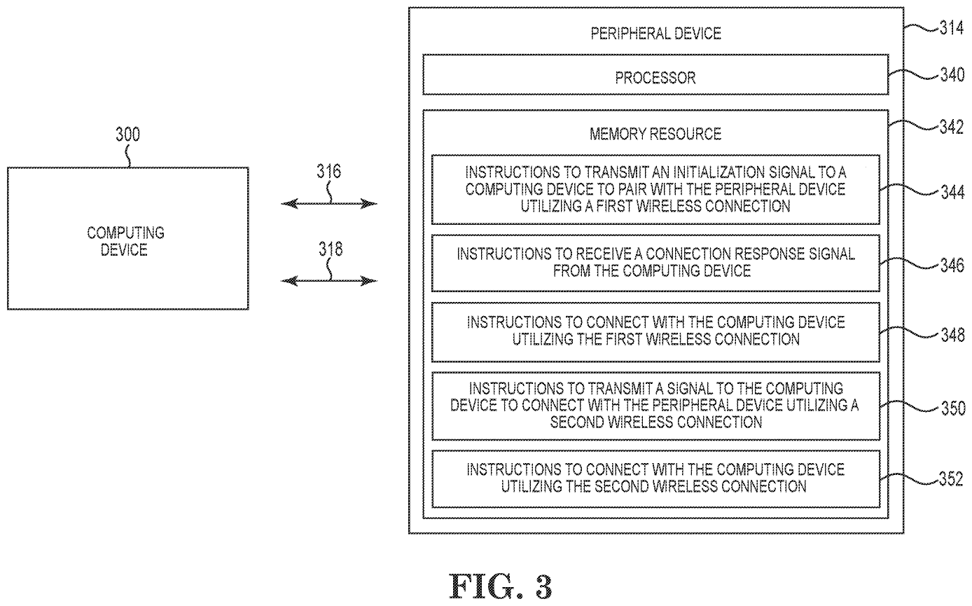

FIG. 3 is a block diagram of an example of a peripheral device 314 pairing to a computing device 300. In some examples, the peripheral device 314 includes a processor 340 communicatively coupled to a memory resource 342. As described further herein, the memory resource 342 includes instructions 344, 346, 348, 350, 352, stored on the memory resource 342 and executed by the processor 340 to perform particular functions.

As used herein, the processor 340 includes, but is not limited to: a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions 344, 346, 348, 350, 352. In other examples, the peripheral device 314 includes instructions 344, 346, 348, 350, 352, stored on a machine-readable medium (e.g., memory resource 342, non-transitory computer-readable medium, etc.) and executable by the processor 340. In a specific example, the peripheral device 314 utilizes a non-transitory computer-readable medium storing instructions 344, 346, 348, 350, 352, that, when executed, cause the processor 340 to perform corresponding functions.

The memory resource 342 may be electronic, magnetic, optical, or other physical storage device that stores executable instructions. Thus, a non-transitory machine-readable medium (MRM) (e.g., the memory resource 342) may be, for example, a non-transitory MRM comprising Random-Access Memory (RAM), read-only memory (ROM), an Electrically-Erasable Programmable ROM (EEPROM), a storage drive, an optical disc, and the like. The non-transitory machine-readable medium (e.g., the memory resource 342) may be disposed within a controller and/or computing device. In this example, the executable instructions 344, 346, 348, 350, 352, can be “installed” on the device. Additionally, and/or alternatively, the non-transitory machine-readable medium (e.g., the memory resource 342) can be a portable, external or remote storage medium, for example, that allows a computing system to download the instructions 344, 346, 348, 350, 352, from the portable/external/remote storage medium. In this situation, the executable instructions may be part of an “installation package.” As described herein, the non-transitory machine-readable medium (e.g., the memory resource 342) can be encoded with executable instructions for determining whether a fluid level of a fluid ejection device exceeds a threshold capacity.

In some examples, the peripheral device 314 may be paired with the computing device 300 to connect with the peripheral device 314 through a first wireless connection 316 and a second wireless connection 318. For example, the peripheral device 314 may be set to a wirelessly discoverable mode (e.g., turning on the device, toggling a switch, pressing a button, selecting a mode on the peripheral device 314, etc.). A first wireless protocol may be activated on the computing device 300. Activating the first wireless protocol may allow the computing device 300 to recognize peripheral devices available to pair with the computing device 300.

In some examples, the memory resource 342 includes instructions 344 that are executed by the processor 340 to transmit an initialization signal to the computing device 300. The initialization signal may be a signal transmitted to the computing device 300 to pair with the peripheral device 314 utilizing the first wireless connection 316.

In some examples, the memory resource 342 includes instructions 346 that are executed by the processor 340 to receive a connection response signal from the computing device 300. The connection response signal may be received in response to the computing device 300 receiving the initialization signal from the peripheral device 314 to pair with the peripheral device 314 utilizing the first wireless connection 316. The connection response signal may include authorization for the peripheral device 314 to connect to the computing device 300.

In some examples, the memory resource 342 includes instructions 348 that are executed by the processor 340 to connect with the computing device 300. The peripheral device 314 may wirelessly connect with the computing device 300 utilizing the first wireless connection 316. The peripheral device 314 may connect with the computing device 300 utilizing the first wireless protocol. As such, the first wireless connection 316 may utilize the first wireless protocol for communication between the peripheral device 314 and the computing device 300.

In some examples, the memory resource 342 includes instructions 350 that are executed by the processor 340 to transmit a signal to the computing device 300 utilizing the previously established first wireless connection 316. The signal may be transmitted in response to the peripheral device 314 establishing the first wireless connection 316 with the computing device 300. For example, the signal may be an unsolicited signal (e.g., transmitted without user interaction). The peripheral device 314 may transmit the signal to the computing device 300 to connect with the peripheral device 314 utilizing the second wireless connection 318. The peripheral device 314 may transmit the signal to the computing device 300 to connect with the peripheral device 314 utilizing a second wireless protocol.

In some examples, the first wireless connection 316 may utilize a BT protocol and the second wireless connection 318 may utilize a ULL protocol. In this example, the signal transmitted from the peripheral device 314 to the computing device 300 may include a MAC Address associated with the ULL protocol of the peripheral device 314. The signal may be transmitted via the BT protocol connection previously established through the first wireless connection 316. The MAC Address of the ULL protocol of the peripheral device 314 may be transmitted for connection to the peripheral device 314 via the ULL protocol utilizing the second wireless connection 318.

In some examples, the first wireless connection 316 may utilize the ULL protocol and the second wireless connection 318 may utilize the BT protocol. In some examples, the signal transmitted from the peripheral device 314 to the computing device 300 may include a MAC Address associated with the BT protocol of the peripheral device 314. The signal may be transmitted via the ULL protocol connection previously established through the first wireless connection 316. The MAC Address of the BT protocol of the peripheral device 314 may be transmitted for connection to the peripheral device 314 via the BT protocol utilizing the second wireless connection 318.

In some examples, the first wireless connection 316 may utilize the ULL protocol and the second wireless connection 318 may utilize the BT protocol. In some examples, the signal transmitted from the peripheral device 314 to the computing device 300 may include a swift pairing notification for the computing device 300 to connect with the peripheral device 314 via the BT protocol utilizing the second wireless connection 318.

In some examples, the memory resource 342 includes instructions 352 that are executed by the processor 340 to connect with the computing device 300 utilizing the second wireless connection 318. The peripheral device 314 may connect with the computing device 300 utilizing the second wireless protocol. As such, the peripheral device 314 may be connected to the computing device 300 via the first wireless connection 316 and the second wireless connection 318. In some examples, the peripheral device 314 may unassistedly (e.g., without user interaction) connect to the second wireless connection 318 of the computing device 300.

FIG. 4 illustrates an example of a first wireless connection 416 and a second wireless connection 418 between a computing device 400 and a peripheral device 414. As illustrated in FIG. 4, the computing device 400 may display a window 454 during connection with the peripheral device 414.

For example, the computing device 400 may be activated to enable the computing device 400 to be paired with a peripheral device 414 utilizing the first wireless connection 416. In this example, the display window 454 may be a pairing activation window. The activation window may include settings to select a first wireless protocol for connection with the peripheral device 414 via the first wireless connection 416. The activation window may include a selectable list of discoverable peripheral devices including the peripheral device 414. Selecting the peripheral device 414 may enable the computing device 400 to connect with the peripheral device 414 via the first wireless connection 416 utilizing first wireless protocol.

The peripheral device 414 may send a signal to the computing device 400 to pair with the peripheral device 414 utilizing a second wireless protocol, as is previously described herein. In some examples, prior to connecting with the peripheral device 414 utilizing the second wireless protocol, the computing device 400 may display a pop-up window to confirm connecting with the peripheral device 414. In this example, the display window 454 may be the pop-up window utilized to confirm connecting with the peripheral device 414. In some examples, after connecting with the peripheral device 414 utilizing the second wireless protocol, the computing device 400 may present a pop-up window to display a connection completion notification. In this example, the display window 454 may be the connection completion notification window.

In some examples, the peripheral device 414 may be a device capable of converted audio signals received from the computing device 400 to sound. In some examples, the peripheral device 414 may be a device that includes a speaker for broadcasting the sound (e.g., headphones, earphones, etc.). The computing device 400 may be utilized to listen to music, a book, a video, etc. utilizing a wireless protocol (e.g., BT) via a wireless connection (e.g., the first wireless connection 416 or the second wireless connection 418). Additionally, the computing device 400 may be utilized as a gaming device utilizing a wireless protocol (e.g., ULL) via a wireless connection (e.g., the first wireless connection 416 or the second wireless connection 418).

The computing device 400 may transmit to the peripheral device 414, a first audio signal through the first wireless connection 416 and a second audio signal through the second wireless connection 418. As such, the peripheral device 414 may receive the first audio signal from the computing device 400 via the first wireless connection 416 and the second audio signal from the computing device 400 via the second wireless connection 418.

The BT protocol may have been selected from the activation window (e.g., display window 454) during the initial pairing between the computing device 400 and the peripheral device 414. As such, the first audio signal may be associated with the BT protocol and the second audio signal may be associated with the ULL protocol. Correspondingly, ULL protocol may have been selected from the activation window during the initial pairing between the computing device 400 and the peripheral device 414. As such, the first audio signal may be associated with the ULL protocol and the second audio signal may be associated with the BT protocol.

In some examples, the computing device 400 may be utilized to listen to music, a book, a video, etc. at the same time as for gaming. In some examples, a daemon associated with the computing device 400 may include instructions to determine a priority between transmitting the first audio signal via the first wireless connection 416 and transmitting the second audio signal via the second wireless connection 418. In some examples, the computing device 400 may display a window to select transmitting the first audio or the second audio. In this example, the display window 454 may be a connection priority selection window.

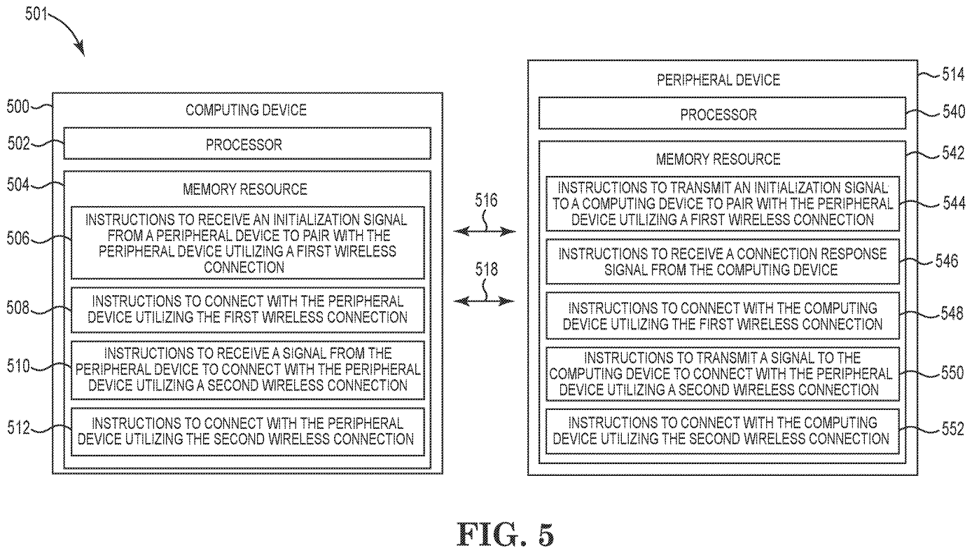

FIG. 5 is a block diagram of an example of a system 501 for pairing a computing device 500 and a peripheral device 514. In some examples, peripheral device 514 includes the same or similar elements as peripheral device 314 as referenced in FIG. 3. For example, the peripheral device 514 includes a first processor 540 and a first memory device 542. In some examples, computing device 500 includes the same or similar elements as computing device 100 as referenced in FIG. 1. For example, the computing device 500 includes a second processor 502 and a second memory resource 504.

In some examples, the first processor 540 of the peripheral device 514 is a device that includes hardware, such as an ASIC, central processing unit (CPU) or other processing resource to execute particular instructions 544, 546, 548, 550, 552. In some examples, the instructions 544, 546, 548, 550, 552, are stored on a non-transitory computer readable medium (e.g., first memory resource 542, etc.) and executed by the first processor 540 to perform the corresponding functions.

In some examples, the second processor 502 of the computing device 500 is a device that includes hardware, such as an ASIC, central processing unit (CPU) or other processing resource to execute particular instructions 506, 508, 510, 512. In some examples, the instructions 506, 508, 510, 512, are stored on a non-transitory computer readable medium (e.g., second memory resource 504, etc.) and executed by the second processor 502 to perform the corresponding functions.

In some examples, the computing device 500 may be paired with the peripheral device 514 to connect with the peripheral device 514 through a first wireless connection 516 and a second wireless connection 518. For example, the computing device 500 may be activated to recognize peripheral devices available to pair with the computing device 500 utilizing the first wireless protocol. The peripheral device 514 may be set to a wirelessly discoverable mode and may be recognized by the computing device 500.

In some examples, the first memory resource 542 of the peripheral device 514 includes instructions 544 that are executed by the first processor 540 of the peripheral device 514 to transmit an initialization signal to the computing device 500 to pair with the peripheral device 514 utilizing the first wireless connection 516.

In some examples, the second memory resource 504 of the computing device 500 includes instructions 506 that are executed by the second processor 502 of the computing device 500 to receive the initialization signal from the peripheral device 514. The initialization signal may be a signal received from the peripheral device 514 to pair with the peripheral device 514 utilizing the first wireless connection 516.

In some examples, the second memory resource 504 includes instructions 508 that are executed by the second processor 502 to connect with the peripheral device 514. In some examples, the computing device 500 may display the peripheral device 514 available for pairing for selection and to confirm connection. In some examples, the computing device 500 may connect with the peripheral device 514 without user interaction. As such, the computing device 500 may authorize the first wireless connection 516 with the peripheral device 514. The computing device 500 may wirelessly connect with the peripheral device 514 utilizing the first wireless protocol via the first wireless connection 516.

In some examples, the first memory resource 542 includes instructions 546 that are executed by the first processor 540 to receive a connection response signal from the computing device 500. The connection response signal may be received in response to the computing device 500 receiving the initialization signal from the peripheral device 514 to pair with the peripheral device 514 utilizing the first wireless connection 516. The connection response signal may include authorization for the peripheral device 514 to connect to the computing device 500.

In some examples, the first memory resource 542 includes instructions 548 that are executed by the first processor 540 to connect with the computing device 500. The peripheral device 514 may wirelessly connect with the computing device 500 utilizing the first wireless protocol via the first wireless connection 516. As such, the first wireless protocol may be utilized for communication between the computing device 500 and the peripheral device 514.

In some examples, the first memory resource 542 includes instructions 550 that are executed by the first processor 540 to transmit an unsolicited (e.g., transmitted without user interaction) signal to the computing device 500 utilizing the previously established first wireless connection 516. The signal may be transmitted in response to establishing the first wireless connection 516. The peripheral device 514 may transmit the signal to the computing device 500 to connect with the peripheral device 514 utilizing the second wireless protocol via the second wireless connection 518.

In some examples, the signal transmitted from the peripheral device 514 to the computing device 500 may include a MAC Address associated with a second wireless protocol of the peripheral device 514. The MAC Address may be transmitted for connection to the peripheral device 514 utilizing the second wireless protocol via the second wireless connection 518.

In some examples, the first wireless connection 516 may utilize a BT protocol and the second wireless connection 518 may utilize a ULL protocol. In this example, the signal transmitted from the peripheral device 514 to the computing device 500 may include a MAC Address associated with the ULL protocol of the peripheral device 514. The signal may be transmitted via the BT protocol connection previously established through the first wireless connection 516.

In some examples, the first wireless connection 516 may utilize the ULL protocol and the second wireless connection 518 may utilize the BT protocol. In some examples, the signal transmitted from the peripheral device 514 to the computing device 500 may include a MAC Address associated with the BT protocol of the peripheral device 514.

In some examples, the signal transmitted from the peripheral device 514 to the computing device 500 may include a swift pairing notification for the computing device 500 to connect with the peripheral device 514 via the BT protocol utilizing the second wireless connection 518. The signal may be transmitted via the ULL protocol connection previously established through the first wireless connection 516.

In some examples, the second memory resource 504 includes instructions 510 that are executed by the second processor 502 to receive the signal from the peripheral device 514 utilizing the previously established first wireless connection 516. The signal may be received in response to establishing the first wireless connection 516. The computing device 500 may receive the signal from the peripheral device 514 to connect with the peripheral device 514 utilizing a second wireless protocol via the second wireless connection 518.

In some examples, the first wireless connection 516 may utilize the ULL protocol and the second wireless connection 518 may utilize the BT protocol. In this example, prior to establishing the second wireless connection 518, the second processor 502 may execute instructions to display a pop-up window (e.g., display window 454 as illustrated in FIG. 4) to confirm connecting with the peripheral device 514 utilizing the second wireless connection 518. As such, the computing device 500 may display a connection confirmation inquiry prior to establishing the second wireless connection 518. Selecting the connection confirmation inquiry (e.g., a displayed button, etc.) may enable connecting the computing device 500 to the peripheral device 514 via the second wireless connection 518.

In some examples, the second memory resource 504 includes instructions 512 that are executed by the second processor 502 to connect with the peripheral device 514 utilizing the second wireless protocol via the second wireless connection 518. As such, the second wireless connection 518 may utilize the second wireless protocol for communication between the computing device 500 and the peripheral device 514.

In some examples, the first memory resource 542 includes instructions 552 that are executed by the first processor 540 to connect with the computing device 500 utilizing the second wireless connection 518. The peripheral device 514 may connect with the computing device 500 utilizing the second wireless protocol via the second wireless connection 518. As such, the peripheral device 514 may be connected to the computing device 500 via the first wireless connection 516 and the second wireless connection 518. In some examples, the peripheral device 514 may unassistedly (e.g., without user interaction) connect to the second wireless connection 518 of the computing device 500.

In some examples, the first wireless connection 516 may utilize a BT protocol and the second wireless connection 518 may utilize a ULL protocol. In this example, after the second wireless connection 518 is established between the computing device 500 and the peripheral device 514, the second processor 502 may execute instructions to display a pop-up window (e.g., display window 454 as illustrated in FIG. 4) including a connection completion notification.

In this way, in response to utilizing the first wireless protocol and the second wireless protocol, the computing device 500 may be paired with the peripheral device 514 by a user through the first wireless connection 516 and unsolicitedly through the second wireless connection 518, reducing connection time and complexity, increasing efficiency, and reducing burdensome to the user.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and devices of the disclosure. Since many examples can be made without departing from the spirit and scope of the system and devices of the disclosure, this specification merely sets forth some of the many possible example configurations and implementations.

What is claimed is:

1. A computing device, comprising:
a processor resource; and
a non-transitory memory resource storing machine-readable instructions stored thereon that, when executed, cause the processor resource to:
receive an initialization signal from a peripheral device to pair with the peripheral device utilizing a first wireless connection;
connect with the peripheral device utilizing the first wireless connection;
in response to establishing the first wireless connection, utilize the first wireless connection to receive a signal from the peripheral device to connect with the peripheral device utilizing a second wireless connection; and
connect with the peripheral device utilizing the second wireless connection, wherein the computing device is connected to the peripheral device via the first wireless connection and the second wireless connection.

2. The computing device of claim 1, wherein the processor is to:
receive, from the peripheral device, a first wireless connection protocol and a media access control (MAC) address associated with the second wireless connection of the peripheral device via the first wireless connection; and
trigger a second wireless connection protocol to connect to the peripheral device utilizing the second wireless connection.

3. The computing device of claim 1, wherein, prior to establishing the second wireless connection, the processor resource is to provide instructions to display a pop-up window to confirm connecting with the peripheral device utilizing the second wireless connection.

4. The computing device of claim 1, wherein the first wireless connection utilizes a Bluetooth (BT) protocol and the second wireless connection utilizes an Ultra Low Latency (ULL) protocol.

5. The computing device of claim 4, wherein the processor resource is to unassistedly connect to the second wireless connection of the peripheral device and display a connection completion notification.

6. The computing device of claim 1, wherein the first wireless connection utilizes an Ultra Low Latency (ULL) protocol and the second wireless connection utilizes a Bluetooth (BT) protocol.

7. The computing device of claim 6, wherein the processor resource further receives a swift pairing notification from the peripheral device.

8. A peripheral device, comprising
a non-transitory memory resource storing machine-readable instructions stored thereon that, when executed, cause a processor to:
transmit an initialization signal to a computing device to pair with the peripheral device utilizing a first wireless connection;
receive a connection response signal from the computing device;
connect with the computing device utilizing the first wireless connection;
in response to an established first wireless connection, utilize the first wireless connection to transmit a signal to the computing device to connect with the peripheral device utilizing a second wireless connection; and
connect with the computing device utilizing the second wireless connection, wherein the peripheral device is connected to the computing device via the first wireless connection and the second wireless connection.

9. The peripheral device of claim 8, wherein:
the first wireless connection utilizes an Ultra Low Latency (ULL) protocol and the second wireless connection utilizes a Bluetooth (BT) protocol; and
the processor is to transmit, to the computing device, a media access control (MAC) address associate with the BT protocol of the peripheral device via the ULL protocol connection for connection to the peripheral device via the BT protocol.

10. The peripheral device of claim 8, wherein:
the first wireless connection utilizes a Bluetooth (BT) protocol and the second wireless connection utilizes an Ultra Low Latency (ULL) protocol; and
the processor is to transmit, to the computing device, a media access control (MAC) address associate with the ULL protocol of the peripheral device via the BT protocol connection for connection to the peripheral device via the ULL protocol.

11. The peripheral device of claim 8, wherein:
the first wireless connection utilizes an Ultra Low Latency (ULL) protocol and the second wireless connection utilizes a Bluetooth (BT) protocol; and
the processor resource further transmits a swift pairing signal to the computing device for connection to the peripheral device via the BT protocol.

12. A system, comprising:
a peripheral device comprising a first non-transitory memory resource storing machine-readable instructions stored thereon that, when executed, cause a first processor to:
transmit an initialization signal to a computing device to pair with the peripheral device utilizing a first wireless connection;
receive a connection response signal from the computing device;
connect with the computing device utilizing the first wireless connection;
in response to an established first wireless connection, utilize the first wireless connection to transmit a signal to the computing device to connect with the peripheral device utilizing a second wireless connection; and
connect with the computing device utilizing the second wireless connection, wherein the peripheral device is connected to the computing device via the first wireless connection and the second wireless connection; and
the computing device comprising a second non-transitory memory resource storing machine-readable instructions stored thereon that, when executed, cause a second processor to:
receive the initialization signal from the peripheral device to pair with the peripheral device utilizing the first wireless connection;
connect with the peripheral device utilizing the first wireless connection;
in response to establishing the first wireless connection, utilize the first wireless connection to receive the signal from the peripheral device to connect with the peripheral device utilizing the second wireless connection; and
connect with the peripheral device utilizing the second wireless connection, wherein the computing device is connected to the peripheral device via the first wireless connection and the second wireless connection.

13. The system of claim 12, wherein the first processor is to receive, from the second processor, a first audio signal via the first wireless connection and a second audio signal via the second wireless connection.

14. The system of claim 13, wherein the second processor is to determine a priority between transmitting the first audio signal via the first wireless connection and transmitting the second audio signal via the second wireless connection.

15. The system of claim 12, wherein:
in response to the first wireless connection utilizing an Ultra Low Latency (ULL) protocol, the second wireless connection is to utilize a Bluetooth (BT) protocol and the computing device is to display a connection confirmation inquiry prior to establishing the second wireless connection; and
in response to the first wireless connection utilizing the BT protocol, the second wireless connection is to utilize the ULL protocol and the computing device is to unassistedly connect to the second wireless connection of the peripheral device and display a connection completion notification after establishing the second wireless connection.
